(19) United States
(12) Patent Application Publication
(10) Pub. No.: US 2003/0083217 A1
(43) Pub. Date: May 1, 2003

(54) Method for preparing polyborate compounds and uses for same

(76) Inventor: Kevin Kutcel, Strongsville, OH (US)

Correspondence Address: Joseph J. Crimaldi, Renner, Otto, Boisselle & Sklar, LLP, 1621 Euclid Avenue, Nineteenth Floor, Cleveland, OH, 44115, US

(21) Appl. No.: 10/305,575

(22) Filed: Nov. 27, 2002

Related U.S. Application Data
(62) Division of application No. 09/798,401, filed on Mar. 2, 2001.
(60) Provisional application No. 60/206,685, filed on May 24, 2000.

(51) Int. Cl. C11D 1/00

(52) U.S. Cl. 510/345

(57) ABSTRACT

The present invention relates to methods for producing suspensions and/or granular products of polyborates. Methods for making suspensions of both insoluble and soluble polyborates are also disclose. Additionally, uses for such polyborate suspensions and/or granular products are also disclosed.

### TECHNICAL FIELD

The present invention generally relates to methods for making polyborate compounds, polyborate compounds and uses for such polyborate compounds. In one embodiment, the present invention relates methods of making soluble polyborates having which utilizes boric acid and at least one caustic sodium compound, and uses for such sodium polyborates. In another embodiment, the present invention relates to methods of making insoluble polyborates which are produced by reacting boric acid with at least one calcium source and optionally at least one caustic sodium source.

### BACKGROUND OF THE INVENTION

Generally, sodium polyborates are produced by reacting boric acid (H₃BO₃) with either 5 mole borax (Na₂B₄O₇.5H₂O) or 10 mole borax (Na₂B₄O₇.10H₂O). The sodium polyborates which are produced by such a method include, but are not limited to, disodium octaborate tetrahydrate (DOT) and sodium pentaborate decahydrate. This method is disclosed in Boron, Metallo-Boron Compounds and Boranes, Roy M. Adams (editor), Interscience Publishers, 1964, pp. 98-109.

The previous methods of making a sodium polyborate are undesirable in certain circumstances because the products produced thereby have low solubilities and do not possess neutral properties.

Boron compounds, including polyborates, are well-known as providing excellent protection to cellulosic materials against insect and fungus attack, and fire. At times, boric acid has been incorporated into composite wood products (e.g., particle board, oriented strand board (OSB), etc.) in order to afford insecticide and fire-retardant properties to composite wood products.

Some applications are sensitive to water, such as the use of a borate compound in a composite wood product. Since boric acid has 44 percent water, the use of boric acid is not desirable. Additionally, a water soluble boron compound, such as a sodium borate, is not desirable. This is because a number of problems exist with the use of such compounds. When boric acid is heated the water contained therein begins to release at very low temperatures.

In the production of composite wood products, as the board is pressed together the large quantity of water in the boric acid causes the wood fibers to swell and hinders a smooth board from being produced. In addition, any water in the presence of a soluble borate causes the boric acid or a soluble boron compound to dissolve, thereby permitting the boron ion to react with the resin and/or binder used to bind the wood particles of the board.

U.S. Pat. No. 2,998,310 discloses a method for making readily soluble compositions of sodium borate.

U.S. Pat. No. 4,879,083 discloses applying anhydrous borax and/or zinc borate to wood particles, during the formation of particle board. Such wood particles are also treated with phenol formaldehyde resin. The treated material is consolidated under heat and pressure in order to form a particle board product.

U.S. Pat. No. 5,972,266 relates to a method of producing a composite wood product utilizing a sprayable aqueous dispersion of zinc borate particles. This dispersion is applied onto the surfaces of wood strands along with a suitable binder. The treated wood strands are then subjected to heat and pressure to form a composite wood product.

In view of the above, there is a need in the art for polyborate compounds that have a desired set of properties. For example, there is a need in the art for granular polyborate compositions which have increased particle sizes (i.e., a median particle size of at least about 50 μm), or for polyborate suspensions which have a pH of about 5.5 to about 8.5 (when measured at a solids content of about 50 percent by weight). In another instance, there is a need for an insoluble polyborate which can be placed into suspension so that it may be utilized in the manufacture of composite wood products.

### SUMMARY OF THE INVENTION

The present invention relates to methods for producing suspensions of polyborate compounds and/or granular soluble polyborate compounds, polyborate compounds, and uses for the same.

In accordance with one aspect of the invention, a method of forming a polyborate suspension is disclosed which comprises the steps of: (A) providing boric acid and at least one source of calcium, caustic sodium or mixtures thereof; and (B) forming a suspension of a polyborate compound, wherein the suspension of the polyborate has (1) a viscosity of at least about 300 cps and/or (2) the pH of the suspension of the polyborate is at least about 6 and the median particle size of the polyborate compound in suspension is less than about 100 μm.

In accordance with another aspect of the invention, a suspension of a polyborate is disclosed which comprises at least one sodium polyborate, calcium polyborate or sodium-calcium polyborate, or mixtures thereof, wherein (1) the suspension of the polyborate has a viscosity of at least about 300 cps and/or (2) the pH of the suspension of the polyborate is at least about 7 and the median particle size of the polyborate compound in suspension is less than about 100 μm.

In accordance with another aspect of the invention, a granular polyborate compound is disclosed which comprises a sodium polyborate compound wherein at least about 50 percent of the particles of the granular sodium polyborate are spherical in shape and/or have a median diameter of at least about 50 μm.

Also disclosed, are products which have been treated or uses for such suspensions, granular compounds and polyborate compositions.

### DETAILED DISCLOSURE OF THE EMBODIMENTS

The present invention provides methods for producing suspensions of polyborate compounds and/or granular soluble polyborate compounds. Such polyborates include, but are not limited to, disodium octaborate tetrahydrate (Na₂B₈O₁₃.4H₂O or Na₂O. 4B₂O₃.4H₂O), sodium pentaborate decahydrate (Na₂O .5B₂O₃.10H₂O), dicalcium hexaborates (2CaO .3B₂O₃.H₂O, Ca₂B₆O₁₁.H₂O, 2CaO .3B₂O₃.5H₂O, or Ca₂B₆O₁₁.5H₂O) and/or sodium-calcium pentaborates (NaCaB₅O₉.8H₂O or NaCaB₅O₉.5H₂O).

As used throughout the specification and the claims, a soluble polyborate means a polyborate where a weight percent equal to or greater than 3 weight percent of the anhydrous salt is soluble in water and/or aqueous environments (i.e. environments which contain at least 10 weight percent water) at 25° C. Furthermore, throughout the specification and the claims, an insoluble polyborate means a polyborate where a weight percent of less than 3 weight percent of the anhydrous salt is soluble in water and/or aqueous environments (i.e. environments which contain at least 10 weight percent water at 25° C.

The present invention, as is mentioned above, relates to methods for making polyborate suspensions and granular polyborate compounds produced from such suspensions. In one embodiment, a suspension of a soluble polyborate is produced according to the methods discussed herein. In another embodiment, a suspension of an insoluble polyborate is produced in accordance with the methods discussed herein.

In one embodiment, the invention relates to a method of forming a polyborate suspension comprising the steps of: (A) providing boric acid and at least one source of calcium, caustic sodium or mixtures thereof; and (B) forming a suspension of a polyborate compound, wherein the suspension of the polyborate has (1) a viscosity of at least about 300 cps and/or (2) the pH of the suspension of the polyborate is at least about 6 and the median particle size of the polyborate compound in suspension is less than about 100 μm (or in the range of about 0.001 to about 100 μm, or in the range of about 1 to about 100 μm).

Additionally, it should be noted that in the following specification and claims, range and ratio limits may be combined, and that room temperature means a temperature of about 25° C., and that the pH of a suspension is determined when the solids content of the suspension is equal to about 50 weight percent.

In another embodiment, the invention relates to a suspension of a polyborate comprising at least one polyborate compound. The polyborates include sodium polyborates, calcium polyborates, sodium-calcium polyborates or mixtures thereof. In one embodiment, the suspension of the polyborate has a viscosity of at least about 300 cps and/or the pH of the suspension of the polyborate is at least about 7 and the median particle size of the polyborate compound in suspension is less than about 100 μm.

In another embodiment, the polyborate suspension has a viscosity of at least about 400 cps, or at least about 600 cps, or in the range of about 300 to about 2,000 cps, or in the range of about 300 to about 600 cps (determined using a Brookfiled #2 spindle at 20 rpm).

In another embodiment, the pH of the polyborate suspension is in the range of about 6 to about 13, or about 6.25 to about 12, or about 6.5 to about 11, or about 6.75 to about 10, or about 7 to about 9, or even about 7.25 to about 8.5.

In another embodiment, the median particle size of the polyborate compound in suspension is in the range of about 0.001 to about 100 μm, or in the range of about 1 to about 100 μm, or about 10 to about 100 μm.

In yet another embodiment, the present invention relates to a method of forming a granular sodium polyborate compound comprising the steps of: (A) providing boric acid with at least one caustic sodium source to yield a suspension containing a sodium polyborate compound having a solids content of the suspension is at least about 20 percent by weight; and (B) subjecting the suspension containing the sodium polyborate compound to atomization spray drying at a temperature in the range of about 50° C. to about 95° C. to yield a granular sodium polyborate compound, wherein at least about 50 percent of the particles of the granular sodium polyborate compound are spherical in shape and/or the granular sodium polyborate compound has a median particle diameter of at least about 50 μm.

In yet another embodiment, the present invention relates to a granular polyborate compound comprising a sodium polyborate wherein at least about 50 percent of the particles of the granular sodium polyborate are spherical in shape and have a median diameter of at least about 50 μm, or at least about 75 μm, or at least about 100 μm, or at least about 150 μm, or even in the range of about 50 to about 250 μm.

In still yet another embodiment, the present invention relates to a method of forming a polyborate composition comprising the steps of: (A) providing boric acid with at least one calcium source and optionally at least one caustic sodium source; (B) forming a suspension of an insoluble polyborate selected from calcium polyborates or sodium-calcium polyborates; and (C) adding about 20 to about 80 weight percent of the suspension of step (B) to at least one wax, resin and/or binder (e.g.,an isocyanate binder) in order to produce a polyborate composition, wherein the pH of the suspension of the insoluble polyborate is at least about 7 and the median particle size of the insoluble polyborate particles in suspension are less than about 100 μm.

In another embodiment, the median particle size of the polyborate compound in suspension is in the range of about 0.001 to about 100 μm, or in the range of about 1 to about 100 μm, or about 10 to about 100 μm.

A. Water Soluble Polyborates:

In one embodiment, the polyborates of the present invention are water soluble polyborates. In one instance, such polyborates have a pH in the range of about 5.5 to about 8.5, or even a pH of about 6.5 to about 8.0 (where the pH is measured before the sodium borate compound is dried as noted above). The polyborate compounds of the present invention can be formed from boric acid and a caustic sodium compound (e.g., sodium hydroxide, sodium carbonate, sodium bicarbonate or mixtures thereof), and to uses for such soluble polyborates. Additionally, the soluble polyborate compounds of the present invention have a molar ratio of Na₂O/B₂O₃ of about 0.1 to about 0.4 Na₂O to about 1.0 B₂O₃.

In one embodiment, a soluble polyborate of the present invention is produced by reacting boric acid with sodium hydroxide in solution to produce a soluble polyborate with a Na₂O/B₂O₃ molar ratio of about 0.1 to about 0.4. As the amount of caustic sodium reactant increases the molar ratio of Na₂O/B₂O₃ increases. Conversely, as the amount of caustic sodium reactant decreases the molar ratio Na₂O/B₂O₃ decreases. Alternatively, the amount of boric acid could be altered to achieve similar results.

This method for producing a soluble polyborate is exothermic and generally yields a suspension having a temperature above room temperature. In one embodiment, the temperature of the suspension is initially at least about 40° C., or even at least about 55° C. One variation of this method is used to produce disodium octaborate tetrahydrate which has a molar ratio of Na₂O/B₂O₃ of 0.25 and is believed to proceed as follows:

8H₃BO₃+2NaOH→Na₂OH→NaₙO.4B₂O₃.4H₂O+9H₂O+heat.

Other soluble polyborate compounds can be produced using the above method by altering the amount of sodium hydroxide which is added to the boric acid. For example, sodium pentaborate decahydrate, which has a molar ratio of Na₂O/B₂O₃ of 0.20, can be produced as follows:

10H₃BO₃+2NaOH→Na₂O .5B₂O₃.10H₂O+6H₂O+heat.

If a suspension of the polyborate product is desired, the temperature of the reaction mixture is slowly lowered to room temperature. For example, the temperature of the reaction mixture is lowered by about 0.1° C. to about 2° C. per minute, or even by about 0.1° C. to about 0.5° C. per minute, until a room temperature reaction mixture is obtained. During this temperature decrease the color of the solution turns from tan or light-tan to white. After the temperature of the reaction solution has reached room temperature additional water is added, with or without stirring, to the reaction mixture in order to create a stable suspension. The amount of water added to create the stable suspension is not critical and can be any amount depending upon the amount of boron per weight unit that is desired in the final suspension product.

In another embodiment, a soluble polyborate of the present invention is produced by reacting boric acid with sodium carbonate (Na₂CO₃.H₂O) in solution to produce a soluble polyborate with a Na₂O/B₂O₃ molar ratio of about 0.1 to about 0.4. The molar ratio of Na₂O/B₂O₃ can be controlled by adjusting the amount of sodium hydroxide which is added to the solution. In other words, as the amount of caustic sodium reactant increases the molar ratio of Na₂O/B₂O₃ increases. Conversely, as the amount of caustic sodium reactant decreases the molar ratio Na₂O/B₂O₃ decreases. Alternatively, the amount of boric acid could be altered to achieve similar results.

This method for producing a soluble polyborate is endothermic. One variation of this method is used to produce disodium octaborate tetrahydrate which has a molar ratio of Na₂O/B₂O₃ of 0.25 and is believed to proceed as follows:

8H₃BO₃+Na₂CO₃.H₂O+heat→Na₂O .4B₂O₃.4H₂O+CO_{2(g)}+9H₂O.

Alternatively, other soluble polyborate compounds can be produced using the above method by altering the amount of sodium hydroxide which is added to the boric acid. For example, sodium pentaborate decahydrate, which has a molar ratio of Na₂O/B₂O₃ of 0.20, can be produced as follows:

10H₃BO₃+Na₂CO₃.H₂O+heat→Na₂O .5B₂O₃.10H₂O+CO_{2(g)}+6H₂O.

Once the above reaction is initiated, the reaction mixture quickly cools to a temperature of generally less than about 25° C. While cooling, CO₂ gas is released and the reaction may appear foamy or actually foam. As the reaction solution cools to below about 25° C., the viscosity of the solution tends to increase (the increase is noticeable to the “unaided eye”). In order to maintain the polyborate in a suspension and/or in solution it may be necessary to add additional water. In one embodiment, additional water in an amount of at least about 3 weight percent based on the total amount of boric acid and sodium hydroxide present may be added. In another embodiment, additional water in an amount of at least 7.5 weight percent based on the total amount of boric acid and sodium hydroxide is added. Once the above reaction is complete; the reaction solution can be either dried or used to produce a suspension as is discussed above.

In one embodiment, the amount of water added is calculated based upon the amount of boric acid (including bound water) and caustic present. In another embodiment, the amount of water added is based on the amount of boric acid (excluding bound water) and caustic present.

In another embodiment, a soluble polyborate of the present invention is produced by reacting boric acid with sodium bicarbonate (NaHCO₃) in solution to produce a soluble polyborate with a Na₂O/B₂O₃ molar ratio of about 0.1 to about 0.4. Again, the molar ratio of Na₂O/B₂O₃ can be controlled by adjusting the amount of sodium hydroxide which is added to the solution. In other words, as the amount of caustic sodium reactant increases the molar ratio of Na₂O/B₂O₃ increases. Conversely, as the amount of caustic sodium reactant decreases the molar ratio Na₂O/B₂O₃ decreases. Alternatively, the amount of boric acid could be altered to achieve similar results.

This method for producing a soluble polyborate is endothermic. One variation of this method is used to produce disodium octaborate tetrahydrate which has a molar ratio of Na₂O/B₂O₃ of 0.25 and is believed to proceed as follows:

8H₃BO₃+2NaHCO₃+heat→Na₂O .4B₂O₃.4H₂O+2CO_{2(g)}+9H₂O.

Alternatively, other soluble polyborate compounds can be produced using the above method by altering the amount of sodium hydroxide which is added to the boric acid. For example, sodium pentaborate decahydrate, which has a molar ratio of Na₂O/B₂O₃ of 0.20, can be produced as follows:

10H₃BO₃+2NaHCO₃+heat→Na₂O .5B₂O₃.10H₂O+2CO_{2(g)}+6H₂O.

Once the above reaction is initiated, the reaction mixture quickly cools to a temperature of generally less than about 25° C. While cooling, CO₂ gas is released and the reaction may appear foamy or actually foam. As the reaction solution cools to below about 25° C., the viscosity of the solution tends to increase (the increase is noticeable to the “unaided eye”). In order to maintain the polyborate in suspension and/or in solution it may be necessary to add additional water. In one embodiment, additional water in an amount of at least about 3 weight percent based on the total amount of boric acid and sodium hydroxide present may be added. In another embodiment, additional water in an amount of at least 7.5 weight percent based on the total amount of boric acid and sodium hydroxide is added. Once the above reaction is complete; the suspension so produced can be either dried or used to produce a suspension as is discussed above. In one embodiment, the amount of water added is calculated based upon the amount of boric acid (including bound water) and caustic present. In another embodiment, the amount of water added is based on the amount of boric acid (excluding bound water) and caustic present.

Optionally, in order to increase the speed at which any and/or all of the above reactions occur, additional water may be added to the reaction mixture in an amount of at least about 2.5 weight percent based on the total amount of boric acid and sodium hydroxide present may be added. In another embodiment, additional water in an amount of at least 5 weight percent based on the total amount of boric acid and sodium hydroxide is added. In one embodiment, the amount of water added is calculated based upon the amount of boric acid (including bound water) and caustic present. In another embodiment, the amount of water added is based on the amount of boric acid (excluding bound water) and caustic present.

Another manner in which to increase the reaction speed of any of the reactions discussed above, is to subject any of these reaction mixtures to high speed mixing using any appropriate means (e.g., a cowles blade, a magnetic stir bar, or a high speed mixer or disperser). For example, the reaction can be conducted while undergoing high speed mixing at a speed of about 500 to about 15,000 rpm, or even about 1,000 to about 10,000 rpm using a suitable device (e.g., a high speed mixer or disperser). The reaction mixtures as described herein are subjected to mixing for about 0.5 to about 6 hours, or from about 0.75 to about 4 hours, or even from about 1 to about 4 hours.

While undergoing high speed mixing, the polyborate produced by the any of the reactions discussed above can be utilized to produce a suspension having therein a polyborate having a particle size of less than about 200 μm, or less than about 150 μm, or in the range of about 0.001 to about 200 μm, or even in the range of about 5 to about 100 μm. After the reaction and the mixing are complete, such suspensions have a viscosity of at least about 300 cps, or at least about 400 cps, or at least about 600 cps, or in the range of about 300 to about 2,000 cps, or in the range of about 300 to about 600 cps (determined using a Brookfiled #2 spindle at 20 rpm).

The suspensions produced under mixing according to any of the reactions above dissolve in water. In one embodiment, about 5 to about 10 parts of a suspension produced according the reactions above dissolve in 100 parts of water, or even about 5 to about 20 parts of such suspensions dissolve in 100 parts of water, or even about 5 to about 30 parts of such suspensions dissolve in 100 parts of water. Generally, such suspensions have a solids content of at least about 5 percent by weight, at least about 10 percent by weight, at least about 15 weight percent, at least about 20 weight percent, at least about 25 weight percent. In another embodiment, the above suspensions have a solids content of about 5 to about 80 percent by weight, or about 10 to about 75 percent by weight, or even about 15 to about 70 percent by weight.

It should be noted that the stability of any suspension produced in accordance the above reactions can be further increased by the addition of one or more stabilization agents. Such agents include, but are not limited to, thickening agents, dispersing agents, anti-settling agents or mixtures thereof.

Useful thickening agents include, for example, cellulose derivatives (e.g., starches, alkyl cellulose thickening agents, etc.), clays, amorphous silicas (e.g., precipitated, fumed, gel, etc.) and/or xanthum gums (e.g., those manufactured by Kelco Polymers, San Diego). The amount of thickening agent which can be added to the suspensions of the present invention is from zero to about 4 weight percent, or from about 0.01 to about 3 weight percent, or even from about 0.1 to about 2 weight percent.

In one embodiment, the thickening agent is added to the reaction mixture and/or suspension product by itself. In another embodiment, the thickening agent is mixed with a suitable amount of water (e.g., an equal mixture of water and a thickening agent) prior to being added to either the reaction mixture and/or a suspension product.

Useful dispersing agents include, for example, pH-independent polyacrylate polymeric dispersants such as EFKA® 4550 (available from Lubrizol® of Wickliffe, Ohio); polycarboxylic acid salts; acrylic polymers such as Dumasperse 540, 545 or 590 (manufactured by Hi-Mar Specialities Inc., in Ball Ground, Ga.); sodium salts of acrylic copolymers; oxazoline compounds; polyacrylic acids; or Hydropalat 44 (manufactured by Cognis in Ambler, Pa.). The amount of dispersing agent which can be added to the suspensions of the present invention is from zero to about 3 weight percent, or from about 0.01 to about 2.5 weight percent, or even from about 0.1 to about 1.5 weight percent.

Useful anti-settling agents include, for example, olefinic copolymer anti-settling agents (e.g., those manufactured by Elementis Specialties, Highstown, N.J.); alcohols, etc. The amount of anti-settling agent which can be added to the suspensions of the present invention is from zero to about 4 weight percent, or from about 0.01 to about 3 weight percent, or even from about 0.1 to about 2 weight percent.

If one or more of the above thickening agents, dispersing agents, and/or anti-settling agents are added to a suspension of a polyborate according to the present invention, the compounds can be added individually or in any suitable combination to the boric acid/sodium source reaction while they are reacting.

In one embodiment, any one of suspensions of polyborate produced in accordance with part A of the present invention can be used to produce a granular polyborate product. Such granular polyborate products can be produced with a wide range of generally spherical particle sizes. That is, the median particle size of the granular polyborate particles having can be less than 250 μm. In another embodiment, the median particle size of the granular polyborate particles is greater than 250 μm. In another embodiment, the median particle size of the granular polyborate particles is in the range of about 10 μm to about 250 μm, or about 25 to about 200 μm, or about 50 to about 150, or about 75 to about 100 μm. In one embodiment, the granular polyborate particles are generally spherical in shape.

Varying particle sizes can be achieved by varying the viscosity of the suspension and/or adjusting the speed of the atomizer dish from which the granular product is produced. For example, a suspension having a viscosity in the range of about 400 to about 600 cps and an atomizer speed of about 3,000 to about 5,000 rpm yields granular particles having generally spherical shapes with a median diameter of about 75 μm to about 150 μm.

As the viscosity of the suspensions becomes lower and the atomizer dish speed increases, the particle diameter decreases. Accordingly, the median particle size of a granular polyborate product is directly related to the viscosity of the suspension and the speed of the atomizer dish used to produce the granular product. That is, when the suspension has a low viscosity (e.g., below about 300 cps) and the atomizer is increased to greater than about 5,000 rpm, the median particle size of a granular product produced from such a suspension will generally be less than about 75 μm.

On the other hand, when the viscosity of the suspension is above 600 cps and the atomizer dish is decreased to about 3,500 rpm, the median particle size of a granular product produced from such a suspension will generally be more than about 150 μm. The viscosity of a suspension produced in accordance with the above methods can be adjusted in any suitable manner, for example, by increasing the solids content of the suspension by removing water, or by the adding a thickening agent, in order to yield a suspension having the desired viscosity.

Alternatively, another way to control the viscosity of a suspensions according to the present invention is to vary the temperature of the suspension prior to the formation of a granular product in order to yield a granular product having the desired median particle size. In one embodiment, the temperature of a suspension according to any of the methods discussed above is adjusted to a temperature in the range of about 30° C. to about 95° C. In another embodiment, the temperature of a suspension is adjusted to a temperature in the range of about 50° C. to about 90° C. In yet another embodiment, the temperature of a suspension is adjusted to a temperature in the range of about 60° C. to about 85° C.

If the suspension is placed under pressure higher, the temperature to which a suspension is adjusted may be higher so long as the suspension is prevented from boiling. In one embodiment, when the suspension is under a pressure in the range of about 1.1 atmospheres to about 4 atmospheres, the temperature of the suspension can be in the range of about 90° C. to about 250° C.

The solids content of the reaction solution is adjusted by the addition or removal of solvent (e.g., water) or additive in order to ensure that the solids content of the reaction solution is at least about 15 percent by weight, or at least about 20 percent by weight, or even at least about 30, at least about 40, at least about 50, or at least about 70 percent by weight.

After the viscosity, temperature and solids content of a suspension have been adjusted accordingly, a suspension as described above is stable and can be subjected to spray drying using a high shear dispersing at a temperature of about 30° C. to about 95° C., or a temperature of about 50° C. to about 90° C., or even a temperature of about 60 to about 85° C. to produce a granular polyborate. This is accomplished by feeding the desired liquid suspension into high shear disperser and subjecting it to atomization. In one embodiment, the speed at which the high shear disperser is rotating is in the range of about 1,000 to about 15,000 rpm, or about 2,000 to about 10,000, or about 4,000 to about 8,000, or even about 3,000 to about 5,000 rpm.

Other techniques, such as thin film drying, can be used to produce a granular polyborate.

In another embodiment, heated air is used to atomize the reaction solution. In one embodiment, this heated air has a temperature at the air inlet of the atomizer of about 50° C. to about 200° C., or about 90° C. to about 150° C. It should be noted that the outlet temperature of the heated air will directly affect particle size and stability of the product. In general, a higher outlet temperature is required to produce a stable, granular product. For example, to produce a spherical product with a free moisture content of less than about 0.5% the outlet temperature should be in the range of about 100° C. to about 150° C., or in the range of about 110° C. to about 140° C., or even in the range of about 120° C. to about 130° C. As noted above, if the temperature of the atomizer is greater than 100° C. than the suspension is fed to the atomizer under pressure in order to prevent any water present in the suspension from boiling.

In another embodiment, a spherical product can be produced with a free moisture content of less than about 1%, less than about 1.5%, or even less than about 5% by varying the outlet temperature.

It is the combination of one or more of the above factors (temperature, solids content (both of which affect the viscosity of the suspension), atomization speed, and, if used, the temperature of the heated air) which enable the above process to obtain a solid granular polyborate compound, as defined above. It should be noted that the process for making the above solid granular polyborate compound can be utilized in conjunction with a suspension containing a soluble polyborate compound produced by any one of the methods discussed above.

Optionally, a granular product produced in accordance with any of the above described methods can be dissolved into at least one polyalkylene glycol, or even at least one polyalkylene glycol having an average molecular weight of between about 200 and about 600 and/or an evaporation rate of between about 0.0003 and 1.0 (n−BuAc=1).

The resulting composition can be used to produce a solution which, when applied to wood or a wood-based product, allows greater penetration into the wood to prevent infestation by insect and/or fungi. Such a compound may also be applied directly to living trees for the same purpose. U.S. Pat. Nos. 5,645,828; 5,460,816; 5,296,240; and 5,104,664, which are hereby incorporated in their entirety by reference, disclose a wood treatment composition which utilizes a boron-containing compound in conjunction with a glycerine and/or glycol.

Alternatively, the dry product produced by any one of the above methods can be used to control dust mites as is disclosed in U.S. Pat. No. 5,672,362, which is hereby incorporated in its entirety by reference.

The soluble polyborates produced in accordance with the present invention can be used in a variety of applications. For example, as is disclosed in U.S. Pat. No. 5,698,208 (which is incorporated herein by reference), disodium octaborate tetrahydrate can be used to produce borax compositions which can be used to control Tephritidae fruit flies, by causing such flies to die prematurely or which interfere with the ability of female Tephritidae fruit flies to produce eggs for a period of about seven days.

Still another use for the soluble polyborates produced in accordance with the present invention is disclosed in U.S. Pat. No. 5,670,059 (which is incorporated herein by reference). U.S. Pat. No. 5,670,059 discloses a method and compositions for the treatment of water in recirculating water systems. The method disclosed therein includes providing a boron level of at least 20 ppm in the water which can be provided by disodium octaborate tetrahydrate.

Furthermore, the present methods can be used to produce disodium octaborate tetrahydrate (DOT). As known to those skilled in the art, solutions of disodium octaborate tetrahydrate or the dried product itself have a wide range of uses. Such uses include, but are not limited to, agricultural (in the form of fertilizers or insecticides), personal safety (flame retardants), commercial fuel additives, and wood preservation (e.g., as a fungicide or insecticide).

The examples below are illustrative of the present inventive methods for producing a suspension or granular product of a soluble polyborate having a molar ratio of Na₂O/B₂O₃ of about 0.1 to about 0.4.

### EXAMPLES

### Example 1

A suspension of a soluble sodium polyborate is produced by reacting 20.7 grams of boric acid with 6.7 grams of NaOH (50% solution in water) to produce a soluble sodium polyborate with a molar ratio of 0.25 Na₂O/B₂O₃. Once the reaction is initiated, it is highly exothermic and produces a solution with a temperature of 77° C. and a low viscosity. This solution is then mixed under high shear using a cowles blade for 1 hour while the temperature is slowly decreased to room temperature (e.g., 25° C.). During the decrease in temperature the viscosity of the solution increases and it changes color from light tan to white. After the above color change occurs, 22.6 grams of water is added to the solution to create a stable suspension of disodium octaborate tetrahydrate which contains 7.5% by weight boron.

### Example 2

A suspension of a soluble sodium polyborate is produced by reacting 20.7 grams of boric acid with 6.7 grams of NaOH (50% solution in water) to produce a soluble sodium polyborate with a molar ratio of 0.25 Na₂O/B₂O₃. Next, the solution is mixed under high shear using a cowles blade for 10 minutes to assure reaction of the boric acid with the NaOH. Next, 0.1% by weight (based on the total weight of the boric acid/NaOH/water solution) of Raybo 63-Disperse® (available from Raybo Chemical Co., Huntington, W. Va.) was added to the mixture and the mixing is continued for an additional 30 minutes. After the additional 30 minutes of mixing, 22.6 grams of water is added to the solution to create a stable suspension of disodium octaborate tetrahydrate which contains 7.5% by weight boron.

It should be noted that addition of the 63-Disperse® before the reaction is totally complete causes the 63-Disperse® to react with the NaOH, the viscosity of the solution to increase, and the solution to turn from tan to white as soon as the 63-Disperse® is added. Due to the addition of 63-Disperse®, the resulting suspension of this Example is stable in storage (i.e. more resilient to settling) unlike the product produced in accordance with Example 1.

### Example 3

A dried soluble sodium polyborate is produced by reacting 20.7 grams of boric acid with 6.7 grams of NaOH (50% solution in water) to produce a soluble sodium polyborate with a molar ratio of 0.25 Na₂O/B₂O₃. Once the reaction is initiated, it is highly exothermic and produces a solution with a temperature of 77° C. and a low viscosity. Next, the temperature of the solution is slowly decreased to 55° C. in order to maintain the lower viscosity solution. The resulting solution is pumped into a spray dryer and dried to produce dried disodium octaborate tetrahydrate (i.e. a sodium polyborate with a molar ratio of 0.25 Na₂O/B₂O₃).

### Example 4

A dried soluble sodium polyborate is produced by reacting 20.7 grams of boric acid with 4.5 grams of Na₂CO₃ to produce a soluble sodium polyborate with a molar ratio of 0.25 Na₂O/B₂O₃. Another 2.1 grams of water is added in order to help initiate the reaction (about 8.3% of total weight of the above boric acid/NaOH solution). Once the reaction is initiated, it is highly endothermic and quickly cools to 18° C. The solution is foamy due to the release of CO₂ gas. This solution is then mixed under high shear using a cowles blade for about 2 to about 4 hours (or until all of the gas is released) while the temperature of the solution is slowly rises back to room temperature. As the temperature of the solution increases, the viscosity of the solution increases (again this is noticeable to the “unaided eye”). In order to maintain the solubility of the sodium polyborate product 4 grams of water is added. Additional water may be added as needed to maintain the solubility of the sodium polyborate product. The need for additional water can be recognized by the precipitation of the sodium polyborate product from the reaction solution. The resulting stable suspension contains disodium octaborate tetrahydrate (i.e. a sodium polyborate with a molar ratio of 0.25 Na₂O/B₂O₃).

### Example 5

A dried soluble sodium polyborate is produced by reacting 20.7 grams of boric acid with 9.0 grams of NaHCO₃ to produce a soluble sodium polyborate with a molar ratio of 0.25 Na₂O/B₂O₃. Another 2.3 grams of water is added in order to help initiate the reaction (7.7% of total weight of the above boric acid/NaOH solution). Once the reaction is initiated, it is highly endothermic and quickly cools to 18° C. The solution is foamy due to the release of CO₂ gas. This solution is then mixed under high shear using a cowles blade for about 2 to about 4 hours (or until all of the gas is released) while the temperature of the solution is slowly rises back to room temperature. As the temperature of the solution increases, the viscosity of the solution increases (again this is noticeable to the “unaided eye”). In order to maintain the solubility of the sodium polyborate product 4 grams of water is added. Additional water may be added as needed to maintain the solubility of the sodium polyborate product. The need for additional water can be recognized by the precipitation of the sodium polyborate product from the reaction solution. The resulting stable suspension contains disodium octaborate tetrahydrate (i.e. a sodium polyborate with a molar ratio of 0.25 Na₂O/B₂O₃).

### Example 6

A suspension of a soluble sodium polyborate is produced by reacting 2070 grams of boric acid with 670 grams of NaOH (50% solution in water) to produce a soluble sodium polyborate with a molar ratio of 0.25 Na₂O/B₂O₃. Once the reaction is initiated, it is highly exothermic and produces a solution with a temperature of 77° C. and a low viscosity. The pH of the solution is adjusted by adding BA or NaOH to a pH of about 7 to about 7.2. The temperature of this solution is then raised to about 93° C. and the viscosity thereof is determined to be about 400-1,000 cps (Brookfiled #2 spindle at 20 rpm). The suspension is then mixed under high shear at a speed of about 5,500 rpm for about 30 minutes. After mixing, the suspension is subjected to spray atomization to produce a granular polyborate. The majority of the granular polyborate particles are spherical in shape and have a diameter of at least 75 μm.

B. Insoluble Polyborates:

In another embodiment, suspensions of insoluble polyborates are produced from a combination of a boron source (e.g., boric acid) with an alkaline-earth metal component (e.g., calcium, magnesium, etc.). In one embodiment, the present invention relates to a method of making insoluble polyborates (e.g., dicalcium hexaborates (2CaO .3B₂O₃.H₂O, Ca₂B₆O₁₁.H₂O, 2CaO .3B₂O₃.5H₂O, or Ca₂B₆O₁₁.5H₂O), sodium-calcium pentaborates (NaCaB₅O₉.8H₂O or NaCaB₅O₉.5H₂O)) via the reaction of boric acid with a calcium source (e.g., Ca(OH)₂, CaCO₃ or CaO) and optionally a sodium source (e.g., NaOH, NaHCO₃, or Na₂CO₃). The sodium source is utilized when the production of a sodium-calcium pentaborate is desired. Also disclosed are uses for compounds/suspensions made in accordance with the methods described below.

In one embodiment, an insoluble calcium polyborate is produced by reacting boric acid with a calcium source. This reaction can be accomplished, for example, as follows:

6H₃BO₃+2CaO+heat→Ca₂B₆O₁₁.5H₂O+4H₂O.

The above reaction is conducted under high speed mixing using any appropriate means (e.g., a cowles blade, a magnetic stir bar, or a high speed mixer or disperser). Additionally, a suitable amount of water is added to the reaction to produce a suspension having at least about 40 percent by weight solids. In another embodiment, a suitable amount of water is added to the reaction to produce a suspension having about 50 or about 75 percent by weight solids, or even from about 40 to about 75 percent by weight solids.

For example, the reaction can be conducted while undergoing high speed mixing at a speed of about 500 to about 15,000 rpm, or even about 1,000 to about 10,000 rpm using a suitable device (e.g., a high speed mixer or disperser). The reaction mixture according to the above embodiment or any of those discussed below are subjected to mixing for about 0.5 to about 6 hours, or from about 0.75 to about 4 hours, or even from about 1 to about 4 hours.

In another embodiment, an insoluble sodium-calcium polyborate is produced by reacting boric acid, a calcium source and a sodium source. This reaction can be accomplished, for example, as follows:

6H₃BO₃+CaO+NaOH+heat→NaCaB₅O₉.8H₂O

The above reaction is conducted under high speed mixing using any appropriate means (e.g., a cowles blade, a magnetic stir bar, or a high speed mixer or disperser). Additionally, a suitable amount of water is added to the reaction so as to produce a suspension having at least about 40 percent by weight solids, about 50 percent by weight solids, or about 75 percent by weight solids. In another embodiment, the suspension has a solids content of about 40 to about 75 percent by weight.

For example, the reaction can be conducted while undergoing high speed mixing at a speed of about 500 to about 15,000 rpm, or even about 1,000 to about 10,000 rpm using a suitable device (e.g., a high speed mixer or disperser). The above reaction mixture is subjected to mixing for about 0.5 to about 6 hours, or from about 0.75 to about 4 hours, or even from about 1 to about 4 hours.

While undergoing high speed mixing, the polyborate suspensions produced according to the reactions immediately above can be subjected to high shear mixing which to produce insoluble polyborate suspensions having a median particle size of less than about 200 μm, or less than about 100 μm. In another embodiment, the median particle size is in the range of about 0.001 to about 200 μm, or about 1 to about 100 μm, or even about 10 to about 100 μm. After the reaction and the mixing are complete, such suspensions have a viscosity of about 200 to about 2,000 cps, or a viscosity of about 200 to about 800 cps, or even a viscosity of about 400 to about 600 cps (determined using a Brookfiled #2 spindle at 20 rpm).

Furthermore, either one of the above reactions, or analogs thereto, can be performed using slightly different molar ratios of the reactants utilized therein so long as the reaction product is a suspension of an insoluble polyborate having a pH greater than about 6.5, or greater than about 7, or even greater than about 7.5. For example, with regard to the production of a calcium polyborate, the molar ratio of boric acid to calcium in the calcium source can be in the range of about 3:0.75-1.25, or even in the range of about 3:0.9-1.2. With regard to the production of a sodium-calcium polyborate, the molar ratio of boric acid to sodium in the sodium source to calcium in the calcium source can be in the range of about 5:0.8-1.2:0.8-1.2, or even in the range of 5:0.91.1:0.9-1.1. This is possible because the insoluble polyborate produced in accordance with the reactions discussed in part B of the present invention which is not crystallized in solution, but is maintained in an amorphous state.

In another embodiment, a naturally occurring colemanite (Ca₂B₆O₁₁35H₂O) and/or ulexite (NaCaB₅O₉.8H₂O) can be used to produce the suspensions described above. In such cases, an appropriate amount of water is added to either one of the naturally occurring products in order to produce as suitable suspension as described above. It should be noted that although naturally occurring colemanite and/or ulexite can be used in the present invention, such compounds generally occur in conjunction with an undesirable amount arsenic. Accordingly, in some applications a synthetic colemanite and/or ulexite produced in accordance with the present invention may be favored.

It should be noted that the stability of any suspension produced in accordance the above reactions can be further increased by the addition of one or more stabilization agents. Such agents include, but are not limited to, thickening agents, dispersing agents, anti-settling agents or mixtures thereof.

Useful thickening agents include, for example, cellulose derivatives (e.g., starches, alkyl cellulose thickening agents, etc.), clays, amorphous silicas (e.g., precipitated, fumed, gel, etc.) and/or xanthum gums (e.g., those manufactured by Kelco Polymers, San Diego). The amount of thickening agent which can be added to the suspensions of the present invention is from zero to about 4 weight percent, or from about 0.01 to about 3 weight percent, or even from about 0.1 to about 2 weight percent.

In one embodiment, the thickening agent is added to the reaction mixture and/or suspension product by itself. In another embodiment, the thickening agent is mixed with a suitable amount of water (e.g., an equal mixture of water and a thickening agent) prior to being added to either the reaction mixture and/or a suspension product.

Useful dispersing agents include, for example, pH-independent polyacrylate polymeric dispersants such as EFKA® 4550 (available from Lubrizol® of Wickliffe, Ohio); polycarboxylic acid salts; acrylic polymers such as Dumasperse 540, 545 or 590 (manufactured by Hi-Mar Specialities Inc., in Ball Ground, Ga.); sodium salts of acrylic copolymers; oxazoline compounds; polyacrylic acids; or Hydropalat 44 (manufactured by Cognis in Ambler, Pa.). The amount of dispersing agent which can be added to the suspensions of the present invention is from zero to about 3 weight percent, or from about 0.01 to about 2.5 weight percent, or even from about 0.1 to about 1.5 weight percent.

Useful anti-settling agents include, for example, olefinic copolymer anti-settling agents (e.g., those manufactured by Elementis Specialties, Highstown, N.J.); alcohols, etc. The amount of anti-settling agent which can be added to the suspensions of the present invention is from zero to about 4 weight percent, or from about 0.01 to about 3 weight percent, or even from about 0.1 to about 2 weight percent.

If one or more of the above thickening agents, dispersing agents, and/or anti-settling agents are added to a suspension of a polyborate in accordance with one of the methods discussed immediately above, the compounds can be added individually or in any suitable combination to the boric acid/calcium source and optionally sodium source reaction while the compounds are reacting.

### EXAMPLES

### Example 7

A suspension of an insoluble calcium polyborate is produced by reacting 370.98 grams of boric acid with 112.16 grams of CaO and 1027.55 grams of water to under high shear to produce an insoluble calcium polyborate suspension having a solids content of 40 percent solids by weight. During the reaction of the boric acid, CaO and water, 23.48 grams of Hydropalat 44 and 31.31 grams of Rheolate 2001 (Elementis Specialties, Highstown, N.J.) were added to the reaction mixture. The reaction mixture is mixed using a high speed mixer (or disperser) at about 5,500 rpm for about 1 hour. The resulting suspension contains 40 percent by weight solids and an insoluble calcium polyborate with a particle size in the range of about 10 to about 100 microns.

The insoluble calcium polyborate and/or sodium-calcium polyborate suspensions according to part B of the present invention can be used in a number of applications.

For example, the suspensions according to part B of the present invention can be used in the manufacture of composite wood products (e.g., OSB or particle board). The typical process by which OSB and/or particle board is made is described in U.S. Pat. Nos. 4,879,083 and 5,972,266, which are incorporated herein by reference.

Ideally, the addition of an insoluble borate should occur as a liquid as most composite wood product manufacturers currently handle and apply liquids to their composite wood products. Having the insoluble borate as part of either the wax, resin and/or binder would allow an applicator to forego additional steps; assure adequate dispersion of the borate throughout the wood fiber; eliminate the need for capital expenditures related to the handling of powders; and does not cause environmental risks associated with powder exposure.

In one embodiment, the suspension of Example 7 is added to a suitable amount of at least one wax, resin, binder or mixtures thereof. In one embodiment, the amount of polyborate suspension in the total polyborate/wax, resin and/or binder blend is at least about 20 percent by weight, or at least about 30 percent by weight. In another embodiment, the amount of polyborate suspension in the total polyborate/wax, resin and/or binder is in the range of about 20 to about 70 percent by weight, or even about 30 to about 60 percent by weight. An appropriate amount of such a suspension (usually from about 1 to about 5 weight percent of the total weight of the product) is applied to the desired product at the appropriate point in the production process.

Suitable waxes, resins and/or binders for the production of composite wood products are known in the art and any such compounds can be used in conjunction with the insoluble polyborate suspensions described herein. Some typically utilized waxes include nonionic waxes from Borden Chemical that are compatible with phenolic resins or Cascowax EW-50LV. A typical phenolic resin is Cascophen OS745E from Borden Chemical of Columbus, Ohio. A typical binder is methane di-isocyanate binder (MDI), although other suitable binders can be utilized.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including any reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A method of forming a polyborate suspension comprising the steps of:
(A) providing boric acid and at least one source of calcium, caustic sodium or mixtures thereof; and
(B) forming a suspension of a polyborate compound,
wherein the suspension of the polyborate has (1) a viscosity of at least about 300 cps or (2) the pH of the suspension of the polyborate is at least about 6 and the median particle size of the polyborate compound in suspension is less than about 100 μm, and the suspension is free of clay.

2. The method of claim 1, wherein the caustic sodium source is sodium hydroxide, sodium bicarbonate, sodium carbonate or mixtures thereof.

3. The method of claim 1, further comprising the step of:
drying the suspension of step (B) to yield a granular sodium polyborate compound wherein at least about 50 percent of the granular sodium polyborate particles are spherical in shape, or the granular particles have a median particle size of at least about 50 μm.

4. The method of claim 3, wherein the median particle diameter of the granular sodium polyborate is at least about 100 μm.

5. The method of claim 1, further comprising adding at least one thickening agent, dispersing agent or anti-settling agent during either step (B).

6. The method of claim 1, wherein the calcium source is calcium oxide, calcium carbonate, calcium hydroxide or mixtures thereof.

7. The method of claim 1, wherein the suspension of step (B) contains a sodium-calcium polyborate.

8. The method of claim 1, wherein the suspension of step (B) contains a calcium polyborate.

9. The method of claim 1, further comprising the step of:
adding to the suspension of the polyborate compound from step (B) about 20 to about 80 weight percent of at least one wax, resin or binder in order to produce a polyborate composition.

10. The method of claim 9, wherein about 40 to about 70 weight percent of the at least one wax, resin or binder is added to the polyborate suspension of step (B).

11. The method of claim 1, wherein the median particle size of the polyborate compound in suspension is in the range of about 10 μm to about 100 μm.

12. The method of claim 1, wherein the method further comprises adding at least one polyacrylate dispersing agent to the suspension.

13. The method of claim 12, wherein the polyacrylate dispersing agent is present in an amount in the range of about 0.01 weight percent to about 3 weight percent.

14. The method of claim 1, wherein the method further comprises adding at least one thickening agent to the suspension.

15. The method of claim 14, where the thickening agent is present in an amount in the range of about 0.01 weight percent to about 4 weight percent.

16. A method of forming a granular sodium polyborate compound comprising the steps of:
(A) forming a sodium polyborate by combining boric acid with at least one caustic sodium source to yield a suspension containing a sodium polyborate compound; and
(B) subjecting the suspension containing the sodium polyborate compound to atomization spray drying at a temperature in the range of about 50° C. to about 95° C. to yield a granular sodium polyborate compound,
wherein at least about 50 percent of the particles of the granular sodium polyborate compound are spherical in shape or the granular sodium polyborate compound has a median particle diameter of at least about 50 μm,
wherein the solids content of the suspension is at least about 20 percent by weight and the suspension is free of clay.

17. The method of claim 16, wherein the caustic sodium source is sodium hydroxide, sodium bicarbonate, sodium carbonate or mixtures thereof.

18. The method of claim 16, wherein the median particle diameter of the granular sodium polyborate is at least about 50 μm.

19. The method of claim 16, wherein the median particle diameter of the granular sodium polyborate is at least about 75 μm.

20. The method of claim 16, wherein the median particle diameter of the granular sodium polyborate is at least about 100 μm.

21. The method of claim 16, further comprising adding at least one thickening agent, dispersing agent, anti-settling agent or mixtures thereof during step (A).

22. The method of claim 16, wherein the median particle size of the polyborate compound in suspension is in the range of about 10 μm to about 100 μm.

23. The method of claim 16, wherein the method further comprises adding at least one polyacrylate dispersing agent to the suspension.

24. The method of claim 23, wherein the polyacrylate dispersing agent is present in an amount in the range of about 0.01 weight percent to about 3 weight percent.

25. The method of claim 16, wherein the method further comprises adding at least one at least one thickening agent to the suspension.

26. A method of forming a polyborate composition comprising the steps of:
(A) providing boric acid with at least one calcium source and optionally at least one caustic sodium source;
(B) forming a suspension of an insoluble polyborate selected from calcium polyborates or sodium-calcium polyborates; and
(C) adding to the suspension of the insoluble polyborate compound from step (B) about 20 to about 80 weight percent of at least one wax, resin or binder in order to produce a polyborate composition,
wherein the pH of the suspension of the insoluble polyborate is at least about 7 and the median particle size of the insoluble polyborate particles in suspension are less than about 100 μm, and the suspension is free of clay.

27. The method of claim 26, where the thickening agent is present in an amount in the range of about 0.01 weight percent to about 4 weight percent.
